(19) United States
(12) Patent Application Publication
(10) Pub. No.: US 2018/0285397 A1
(43) Pub. Date: Oct. 4, 2018

(54) ENTITY-CENTRIC LOG INDEXING WITH CONTEXT EMBEDDING

(71) Applicant: Cisco Technology, Inc., San Jose, CA (US)

(72) Inventors: Xinyuan Huang, San Jose, CA (US); Debojyoti Dutta, Santa Clara, CA (US)

(21) Appl. No.: 15/478,304

(22) Filed: Apr. 4, 2017

(51) Int. Cl. G06F 17/30; H04L 12/24; G06N 3/04

(52) U.S. Cl. CPC G06F 17/30321; H04L 41/069; G06N 3/04; G06F 17/30917; G06F 17/30528

(57) ABSTRACT

In one embodiment, a device in a network tokenizes a plurality of strings from unstructured log data into entity tokens and non-entity tokens. The entity tokens identify entities in the network. The device identifies patterns of tokens in the tokenized strings. The device determines entity-centric contexts from the identified patterns. A particular entity-centric context comprises a sequence of tokens that precede or follow an entity token in the tokenized strings. The device associates similar ones of the entity-centric contexts. The device generates a lookup index based in part on the entities and the similar entity-centric contexts.

### TECHNICAL FIELD

The present disclosure relates generally to computer networks, and, more particularly, to entity-centric log indexing with context embedding.

### BACKGROUND

As computer networks continue to evolve, more and more log data is being generated, to capture the state and health of the various entities in the network. In general, structured log data refers to data that employs a predefined level of organization, thereby facilitating searching and other data analysis functions. For example, certain structured data may use the format: {field A, field B, field C}, where specific information is stored in each of the corresponding fields. Thus, if certain information is needed, the system need only look to the appropriate field to obtain this information. However, this is not possible in the case of unstructured log data which, by its very nature, does not have the same predefined organization to it.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example architecture for entity-centric log indexing;

FIG. 4 illustrates an example of the identification of an entity-centric context; and

FIG. 5 illustrates an example simplified procedure for entity-centric log indexing.

### DESCRIPTION OF EXAMPLE EMBODIMENTS

### Overview

According to one or more embodiments of the disclosure, a device in a network tokenizes a plurality of strings from unstructured log data into entity tokens and non-entity tokens. The entity tokens identify entities in the network. The device identifies patterns of tokens in the tokenized strings. The device determines entity-centric contexts from the identified patterns. A particular entity-centric context comprises a sequence of tokens that precede or follow an entity token in the tokenized strings. The device associates similar ones of the entity-centric contexts. The device generates a lookup index based in part on the entities and the similar entity-centric contexts.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

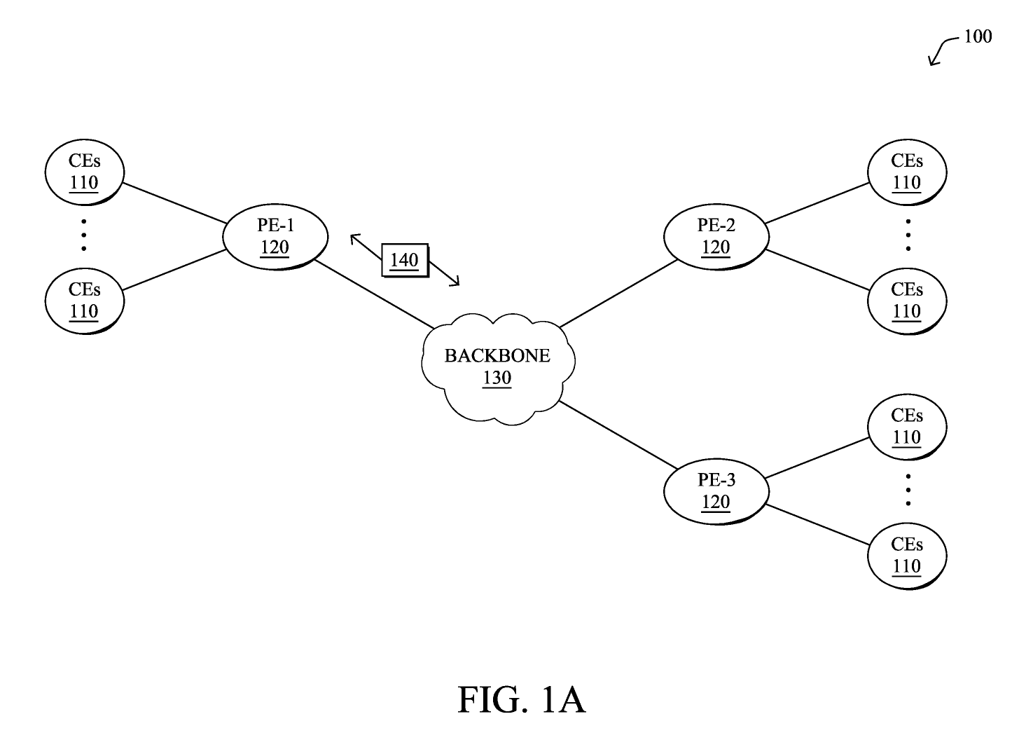

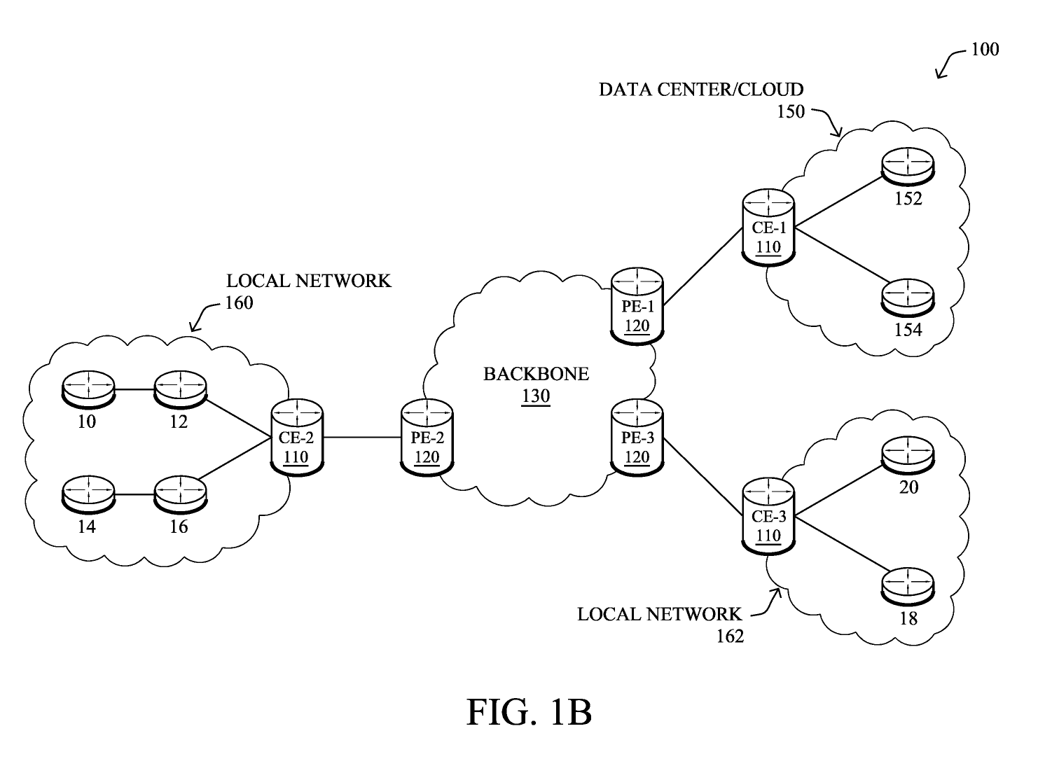

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers), with potentially a backup link (e.g., a 3G/4G/LTE connection). A site of type B may itself be of different types:

2a.) Site Type B1: a site connected to the network using two MPLS VPN links (e.g., from different Service Providers), with potentially a backup link (e.g., a 3G/4G/LTE connection).

2b.) Site Type B2: a site connected to the network using one MPLS VPN link and one link connected to the public Internet, with potentially a backup link (e.g., a 3G/4G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

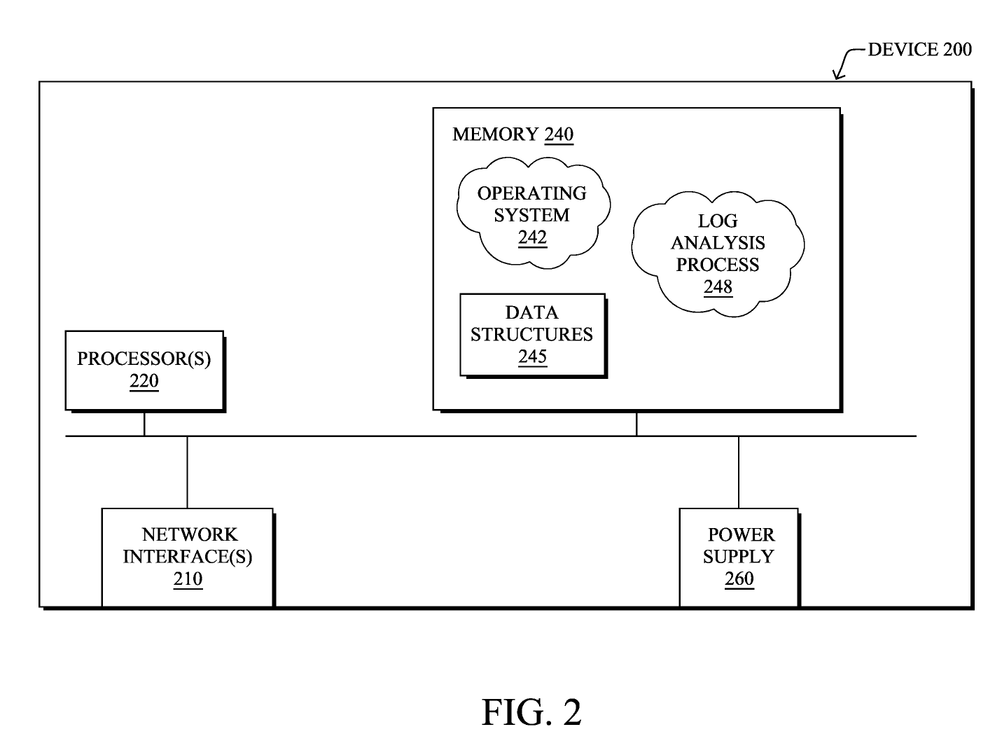

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a log analysis process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

As noted above, the amount of log data generated by network entities is ever increasing. Such entities may include, but are not limited to, virtual machines (VMs), devices, sessions, processes, transactions, IP addresses, uniform resource locators (URLs), and the like. Typically, a defining characteristic of a network entity is a unique identifier that represents the entity (e.g., an IP address and port combination, etc.). During operation, these entities may generate log data regarding their operational states, actions, events, etc., which is often unstructured.

Solving operational problems requires not only statistical analysis of general words in log data, but also an investigation into the specific types of behaviors of the entities. For example, an administrator may wish to review what is happening to a given process and compare it to what is happening to other similar processes. In another example, an administrator may wish to learn what the normal sequence of events should be for a transaction, so that abnormal transactions can be identified.

In the case of unstructured log data, inverted indexing techniques can be used, whereby each token is treated equally and independently (i.e., each token becomes an independent key in the index). However, the entities in machine logs have the nature of having unique identifiers that might not be frequent “words,” even if the same types of entities frequently appear in the logs. In turn, this requires strong domain knowledge and the use of complex queries, to track certain entities in the unstructured logs.

Entity-Centric Log Indexing with Context Embedding

The techniques herein introduce an intelligent, entity-centric indexing method for unstructured machine logs, to support efficient entity behavioral analysis. In some aspects, the techniques herein classify log vocabulary into different roles, such as “special entity” and “non-entity/natural language,” thereby treating the entity type vocabulary in different ways than that of the non-entity words. In further aspects, the techniques herein also allow entity patterns and contexts to be added to a log index, as was as encoding their similarity information through embedding, providing for a more useful index that can efficiently support entity behavioral analysis.

Specifically, according to one or more embodiments of the disclosure as described in detail below, a device in a network tokenizes a plurality of strings from unstructured log data into entity tokens and non-entity tokens. The entity tokens identify entities in the network. The device identifies patterns of tokens in the tokenized strings. The device determines entity-centric contexts from the identified patterns. A particular entity-centric context comprises a sequence of tokens that precede or follow an entity token in the tokenized strings. The device associates similar ones of the entity-centric contexts. The device generates a lookup index based in part on the entities and the similar entity-centric contexts.

Illustratively, the techniques described herein may be performed by hardware, software, and/or firmware, such as in accordance with the log analysis process 248, which may include computer executable instructions executed by the processor 220, to perform functions relating to the techniques described herein.

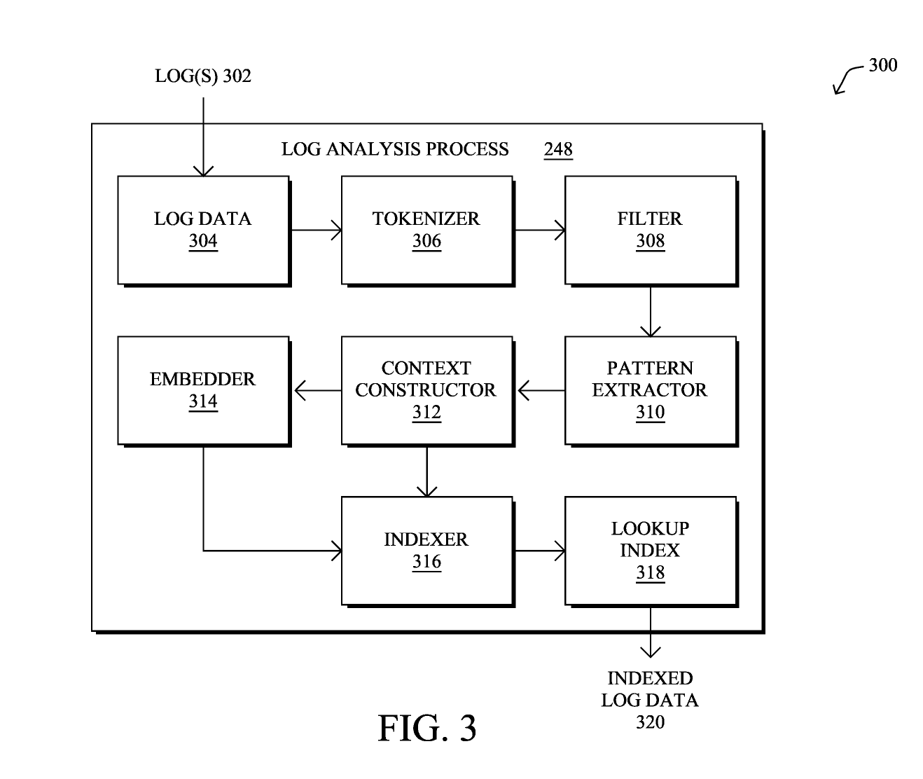

Operationally, FIG. 3 illustrates an example architecture 300 for entity-centric log indexing, according to various embodiments. As shown, log analysis process 248 may include any number of sub-processes and/or may access any number of memory locations. As would be appreciated, these sub-processes and/or memory locations may be located on the same device or implemented in a distributed manner across multiple devices, the combination of which may be viewed as a single system/device that executes log analysis process 248. Further, while certain functionalities are described with respect to the sub-processes and memory locations, these functions can be added, removed, or combined as desire, in further implementations.

Generally, architecture 300 takes a very different approach than that of existing techniques by leveraging syntactic analysis to identify different types of entities from unstructured logs. Further, architecture 300 is operable to encode the similarities between the entities' information into the index through embedding. These approaches provide a more robust log index that can efficiently support advanced behavioral analytics.

As shown, log analysis process 248 may receive log(s) 302 from any number of sources local or remote to the device executing process 248. For example, if the device executing log analysis process 248 is located in a network operation center, the device may receive log(s) 302 from the various entities deployed within the network. In turn, log analysis process 248 may store the textual data from log(s) 302 as log data 304. In one embodiment, log analysis process 248 may also standardize the text within log(s) 302 across any number of source formats, prior to storage as log data 304. For example, Dos/Windows-sourced text files typically use a slightly different text format than that of Unix/Linux-sourced text files. Various delimiters may be used to differentiate strings within log(s) 302 such as event identifiers, line breaks, specialized characters, or the like.

In various embodiments, log analysis process 248 may include a tokenizer 306 that breaks down the strings/lines of log data 304 into individual tokens/words. For example, in the case of a string “creating instance INS001 for service SVC001,” tokenizer 306 may tokenize the string into the following tokens: “creating,” “instance,” “INS001,” “for,” “service,” “SVC001.” In some implementations, tokenizer 306 may not eliminate any symbols within a given string, as may be done by other text analysis approaches, but instead preserve all symbols for further processing.

In various embodiments, tokenizer 306 may also apply a filter 308 to the tokenized strings of log data 304, to discern between entity tokens and non-entity tokens. For example, any token that is also a natural language word may be deemed a non-entity token (e.g., based on one or more natural language dictionaries of tokenizer 306). In other words, rather than simply treating each token within a string equally, log analysis process 248 may treat entity tokens and non-entity tokens separately, thereby allowing an entity-centric approach to be taken.

Once the entity and non-entity tokens have been identified, a pattern extractor 310 may discern the overall pattern of the string/line under analysis. In general, this may be done by mapping all of the entity tokens to wildcard representations. For example, in one embodiment, pattern extractor 310 may apply the following rules to form the representations:
1. All symbols appearing in the entity tokens are mapped to themselves, as-is.
2. Combinations of alphanumeric values are mapped to a specific set of characters (e.g., ##AN).
3. Pure numeric values are mapped to a specific set of characters (e.g., ##N).

By applying the above rules, pattern extractor 310 will convert all of the special entity tokens into a unified representation. For example, an entity token for a service endpoint of “http://10.0.123.91:8000” may be mapped to “##AN://##N.##N.##N.##N:##N.”

Context constructor 312 may determine the “context” for each of the entity patterns from pattern extractor 310. In various embodiments, such a context may comprise a predefined number of tokens or patterns that appear in a given pattern before or after an entity wildcard. In doing so, not only does log analysis process 248 identify that a given log string involves a given entity, but is also able to extract out the non-entity and/or entity tokens/natural language words that surround the given entity, to give context to the entity's appearance within the string.

In various embodiments, the constructed context from context constructor 312 may be used as input to embedder 314. In general, embedder 314 is configured to discern similarities between the contexts. For example, in one embodiment, embedder 314 may map each context to a vector space such that contexts that share the same text will be mapped close to each other in the output space. In other words, the relative distance between vector representations of the contexts may indicate the degree of similarity. In one embodiment, embedder 314 may use machine learning to perform such a mapping. For example, embedder 314 may use a trained neural network having a single projection layer and a single output layer. Such a network could be trained periodically using the following data structure as the result of training: {context-pattern id: (pattern text, embedded vector)}. For new logs 302, the same preprocessing and context extraction by sub-processes 306-312 may be applied, and the projection layer of the network of embedder 314 will be used to embed each encountered entity to a vector.

Indexer 316 may be configured to build a lookup index 318 for each of the assessed strings/lines from log data 304 in an entity-centric manner, by using the outputs of context constructor 312 and/or embedder 314. For example, indexer 316 may create any or all of the following mappings within lookup index 318:

Mapping_1 {entity text: list of [context-pattern id, event id] }

Mapping_2 {context-pattern id: list of [entity text, event id] }

Mapping_3 {context-pattern id: (pattern text, embedded vector)}

Since the entity-centric lookup index 318 includes detailed pattern and similarity information among entities, queries can then be easily made to index 318 to track and analyze the behaviors of the entities. For example, in response to receiving a given query (e.g., for the entities having similar contexts/behaviors as that of an entity specified in the request), log analyzer process 248 may perform the requested lookup and return indexed log data 320 as part of a lookup response.

Entity-centric lookup index 318 may also enable sequence mining, anomaly detection, root cause analysis, and other mechanisms for specific entities by leveraging this indexing approach. For example, given one VM identifier, log analysis process 248 can efficiently search for similar VMs that have similar behavior by performing two steps: 1.) search for context patterns given VM id (entity text) using Mapping_1 above, and 2.) search for other entities (VM) given the context patterns using Mapping_2 above. In another example, Mapping_3 above can be used to identify frequent sequences of log events related to a certain type of entity by simply clustering context patterns. Further searching of related log events corresponding to those sequences can then be performed using Mapping_1 and Mapping_2 in a combined way.

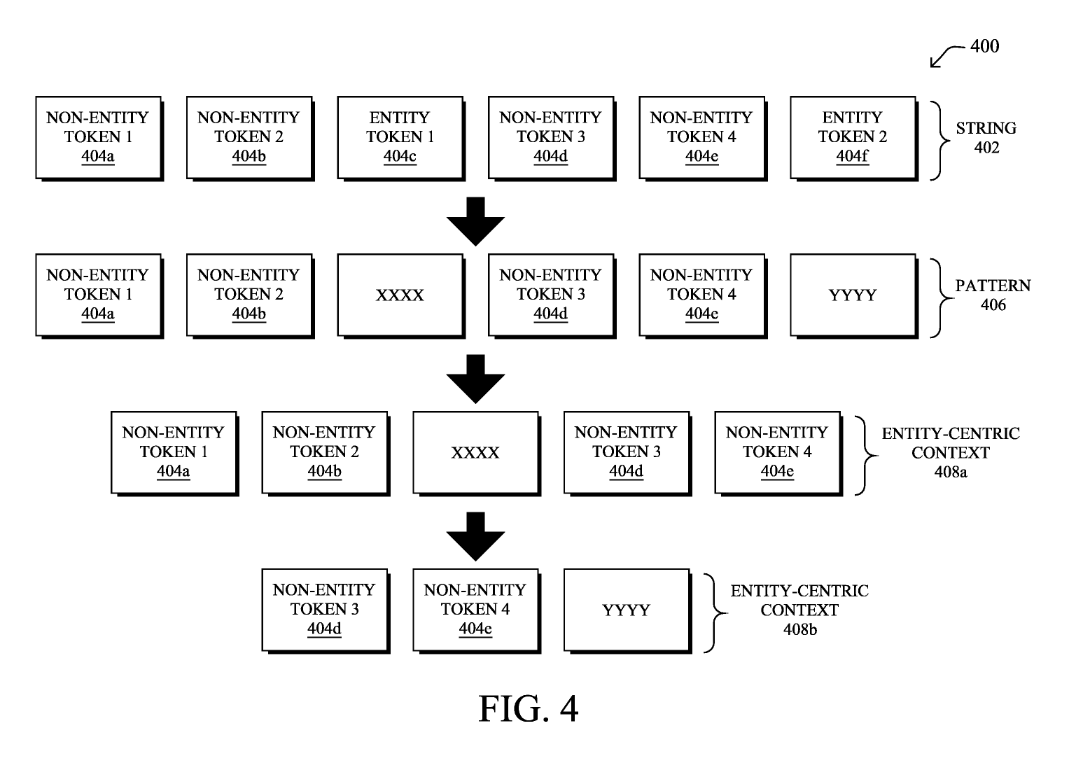

FIG. 4 illustrates an example 400 of the identification of an entity-centric context, according to various embodiments. As shown, the indexing process may begin by tokenizing a given string 402 into tokens 404a-404f. Each of tokens 404a-404f may be categorized as either a non-entity token (e.g., a natural language word) or, alternatively, an entity-related token.

To extract the pattern 406 from string 402, the indexing process may then replace the entity tokens 404c and 404f with wildcard placeholders “XXXX” and “YYYY,” respectively. As would be appreciated, any number of different formats may be used for these placeholders.

Finally, one or more entity-centric contexts 408 can be extracted by capturing the n-number of tokens that appear before and/or after a given entity token placeholder. For example, assume that a context is defined as including the two tokens/words that precede and follow a given entity placeholder. In such a case, pattern 406 may give way to a first entity-centric context 408a for “XXXX” that includes tokens 404a-404b and 404d-404e, as well as a second entity centric context 408b for “YYYY” that includes tokens 404d-404e.

By way of a more concrete example of the indexing techniques herein, consider the following event messages/strings of log data for a given micro-service entity in the network:

TABLE 1

| Event ID | Event Message |
|---|---|
| E1 | creating instance INS001 for service SVC001 |
| E2 | scheduling instance INS001 to node 10.0.0.101 |
| E3 | instance INS001 for service SVC001 successfully created |
| E4 | creating instance INS002 for service SVC001 |
| E5 | scheduling instance INS002 to node 10.0.0.102 |
| E6 | instance INS002 for service SVC001 successfully created |

The indexing system may then tokenize, filter, and extract the following patterns from the messages/strings shown above in Table 1, resulting in the following patterns:

TABLE 2

| Event ID | Event Message Pattern |
|---|---|
| E1 | creating instance ##AN for service ##AN |
| E2 | scheduling instance ##AN to node ##N.##N.##N.##N |
| E3 | instance ##AN for service ##AN successfully created |
| E4 | creating instance ##AN for service ##AN |
| E5 | scheduling instance ##AN to node ##N.##N.##N.##N |
| E6 | instance ##AN for service ##AN successfully created |

Assume now that the indexing system uses a range of two words/tokens before or after a target entity, to extract the entity contexts from the patterns shown in Table 2 above. In such a case, the following may result, with the character “_” being used as a placeholder to represent empty words at the beginning or end of a string under analysis:

TABLE 3

| Context ID | Entity-Centric Context |
|---|---|
| C1 | creating instance ##AN for service |
| C2 | for service ##AN_{—} |
| C3 | scheduling instance ##AN to node |
| C4 | to node ##N.##N.##N.##N_{—} |
| C5 | _instance ##AN for service |
| C6 | for service ##AN successfully created |

To embed the contexts, the indexing system may then map the contexts of Table 3 to vectors in a vector space as shown below in Table 4:

TABLE 4

| Context ID | Context | Embedded Vector |
|---|---|---|
| C1 | creating instance ##AN for service | [0, 0, 0, 1] |
| C2 | for service ##AN_{—} | [0, 0, 1, 0] |
| C3 | scheduling instance ##AN to node | [0, 0, 0, 1] |
| C4 | to node ##N.##N.##N.##N_{—} | [0, 1, 0, 0] |
| C5 | _instance ##AN for service | [0, 0, 0, 1] |
| C6 | for service ##AN successfully created | [0, 0, 1, 0] |

Here, the contexts C1, C3, C5 are mapped to the same vector because they share the exactly the same set of entities in this example. The same is true for contexts C2, C6, which may also be mapped to the same vector. However, note that in many real-word cases, if they share slightly different sets of entities, they will be mapped to vectors that are similar (e.g., close in distance), but not exactly the same. Conversely, if they do not

share similar sets of entities, they will be mapped to very different vectors.

Based on the above, the indexing system can then generate lookup index entries as follows for the indicated mappings:

### Mapping 1:

TABLE 5

| Key | Value |
|---|---|
| “INS001” | [(C1, E1), (C3, E2), (C5, E3)] |
| “INS002” | [(C1, E4), (C3, E5), (C5, E6)] |
| “SVC001” | [(C2, E1), (C2, E4), (C6, E3), (C6, E6)] |
| “10.0.0.101” | [(C4, E2)] |
| “10.0.0.102” | [(C4, E5)] |

### Mapping 2:

TABLE 6

| Key | Value |
|---|---|
| C1 | [(“INS001”, E1), (“INS002”, E4)] |
| C2 | [(“SVC001”, E1), (“SVC001”, E4)] |
| C3 | [(“INS001”, E2), (“INS002”, E5)] |
| C4 | [(“10.0.0.101”, E2), (“10.0.0.102”, E5)] |
| C5 | [(“INS001”, E3), (“INS002”, E6)] |
| C6 | [(“SVC001”, E6), (“SVC001”, E6)] |

### Mapping 3:

TABLE 7

| Key | Value |
|---|---|
| C1 | (“creating instance ##AN for service”, [0, 0, 0, 1]) |
| C2 | (“for service ##AN_”, [0, 0, 1, 0]) |
| C3 | (“scheduling instance ##AN to node”, [0, 0, 0, 1]) |
| C4 | (“to node ##N.##N.##N.##N_”, [0, 1, 0, 0]) |
| C5 | (“_instance ##AN for service”, [0, 0, 0, 1]) |
| C6 | (“for service ##AN successfully created”, [0, 0, 1, 0]) |

By embedding the context within the index, multiple log contexts/event-abstractions can be easily linked that match a certain behavior shared among a type of entities, as opposed to linking a single event or a single entity. For example, “INS001” and “INS002” above are two different entities of the same type, i.e., successfully created instances. Through the embedding, contexts C1, C3, and C5 can also be linked, which match the behavior of this type of entity.

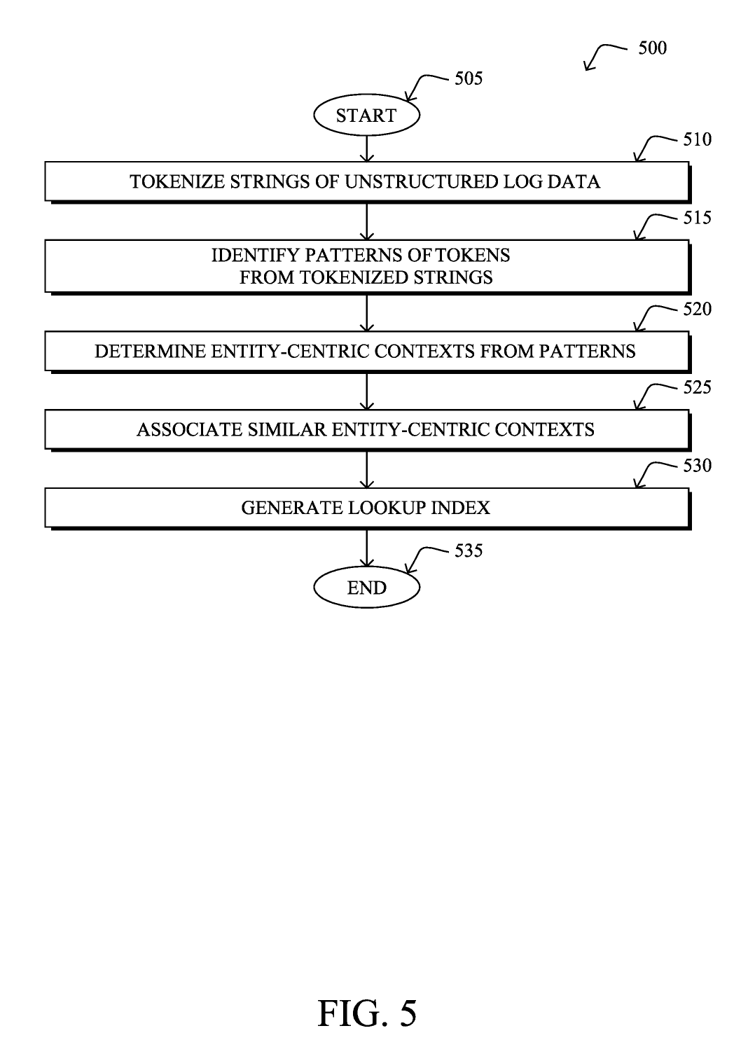

FIG. 5 illustrates an example simplified procedure for entity-centric log indexing in a network in accordance with one or more embodiments described herein. For example, a non-generic, specifically configured device (e.g., device 200) may perform procedure 500 by executing stored instructions (e.g., process 248). The procedure 500 may start at step 505, and continues to step 510, where, as described in greater detail above, the device may tokenize strings of unstructured log data. In various embodiments, the device may label each token as either an entity-related token or a non-entity token. For example, entity tokens may be unique identifiers for, or otherwise represent, the various entities in the network (e.g., devices, virtualized processes, etc.).

At step 515, as detailed above, the device may identify patterns of tokens in the tokenized strings. In some embodiments, the device may identify such a pattern by treating any of the entity tokens within the string as wildcard/placeholder values. In other words, the device may extract out the word pattern of the string, but for the entity-related tokens within the string.

At step 520, the device may determine entity-centric contexts from the patterns identified in step 515, as described in greater detail above. In various embodiments, such an entity-centric context comprises a sequence of non-entity and/or entity tokens that precede or follow a particular entity token in the tokenized strings. For example, a context may include the n-number of tokens/words that appear before and/or after that of the location of an entity token within the string under analysis.

At step 525, as detailed above, the device may associate similar entity-centric contexts. In various embodiments, the device may make such associations by mapping the entity-centric contexts to vectors in a vector space. Similarity may then be treated as a function of distance between the vectors, as the vectors for very similar contexts may also be very similar. In some embodiments, this mapping may be performed using a trained neural network.

At step 530, the device may generate a lookup index based in part on the entities and the similar entity-centric contexts, as described in greater detail above. By inserting this entity-centric information into the index, the index can be easily queried for information such as finding similar entities, identifying the contexts of a certain type of entity, etc. Procedure 500 then ends at step 535.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, efficiently detect domain-specific entities and group up similar types of entities from unstructured logs. The techniques further allow for the encoding of entity information within a log index, facilitating faster searching of a type of entities or similar entities. Additionally, the techniques herein can be used in general log analysis applications and cloud based data pipelines, to support advanced use cases, especially for entity behavior based analysis.

While there have been shown and described illustrative embodiments that provide for entity-centric log indexing, it is to be understood that various other adaptations and modifications may be made within the spirit and scope of the embodiments herein. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
tokenizing, by a device in a network, a plurality of strings from unstructured log data into entity tokens and non-entity tokens, wherein the entity tokens identify entities in the network;
identifying, by the device, patterns of tokens in the tokenized strings;
determining, by the device, entity-centric contexts from the identified patterns, wherein a particular entity-centric context comprises a sequence of tokens that precede or follow an entity token in the tokenized strings;
associating, by the device, similar ones of the entity-centric contexts; and
generating, by the device, a lookup index based in part on the entities and the similar entity-centric contexts.

2. The method as in claim 1, wherein the entities comprise one or more of: network addresses, network services, or virtual processes.

3. The method as in claim 1, further comprising:
receiving, at the device, a lookup request for a particular entity; and
providing, by the device, a lookup response indicative of the entities in the lookup index that have similar entity-centric contexts as that of the particular entity.

4. The method as in claim 1, wherein identifying the patterns of tokens in the tokenized strings comprises:
treating, by the device, the entity tokens that appear in the strings as wildcards.

5. The method as in claim 1, wherein associating similar ones of the entity-centric contexts comprises:
mapping, by the device, the entity-centric contexts to vectors in a vector space, wherein two similar entity-centric contexts are deemed similar to one another based on the distance between their respective vectors in the vector space.

6. The method as in claim 5, wherein mapping the entity-centric contexts to vectors in the vector space comprises:
using, by the device, a trained neural network to map the entity-centric contexts to vectors in the vector space.

7. The method as in claim 1, wherein the entity tokens comprise unique identifiers for the entities.

8. An apparatus, comprising:
one or more network interfaces to communicate with a network;
a processor coupled to the one or more network interfaces and configured to execute a process; and
a memory configured to store the process executable by the processor, the process when executed configured to:
tokenize a plurality of strings from unstructured log data into entity tokens and non-entity tokens, wherein the entity tokens identify entities in the network;
identify patterns of tokens in the tokenized strings;
determine entity-centric contexts from the identified patterns, wherein a particular entity-centric context comprises a sequence of tokens that precede or follow an entity token in the tokenized strings;
associate similar ones of the entity-centric contexts; and
generate a lookup index based in part on the entities and the similar entity-centric contexts.

9. The apparatus as in claim 8, wherein the entities comprise one or more of: network addresses, network services, or virtual processes.

10. The apparatus as in claim 8, wherein the process when executed is further configured to:
receive a lookup request for a particular entity; and
provide a lookup response indicative of the entities in the lookup index that have similar entity-centric contexts as that of the particular entity.

11. The apparatus as in claim 8, wherein the apparatus identifies the patterns of tokens in the tokenized strings by:
treating the entity tokens that appear in the strings as wildcards.

12. The apparatus as in claim 8, wherein the apparatus associates similar ones of the entity-centric contexts by:
mapping the entity-centric contexts to vectors in a vector space, wherein two similar entity-centric contexts are deemed similar to one another based on the distance between their respective vectors in the vector space.

13. The apparatus as in claim 12, wherein the apparatus maps the entity-centric contexts to vectors in the vector space using a trained neural network.

14. The apparatus as in claim 8, wherein the entity tokens comprise unique identifiers for the entities.

15. A tangible, non-transitory, computer-readable medium storing program instructions that cause a device in a network to execute a process comprising:
tokenizing, by the device, a plurality of strings from unstructured log data into entity tokens and non-entity tokens, wherein the entity tokens identify entities in the network;
identifying, by the device, patterns of tokens in the tokenized strings;
determining, by the device, entity-centric contexts from the identified patterns, wherein a particular entity-centric context comprises a sequence of tokens that precede or follow an entity token in the tokenized strings;
associating, by the device, similar ones of the entity-centric contexts; and
generating, by the device, a lookup index based in part on the entities and the similar entity-centric contexts.

16. The computer-readable medium as in claim 15, wherein the entities comprise one or more of: network addresses, network services, or virtual processes.

17. The computer-readable medium as in claim 15, wherein the process further comprises:
receiving, at the device, a lookup request for a particular entity; and
providing, by the device, a lookup response indicative of the entities in the lookup index that have similar entity-centric contexts as that of the particular entity.

18. The computer-readable medium as in claim 15, wherein identifying the patterns of tokens in the tokenized strings comprises:
treating, by the device, the entity tokens that appear in the strings as wildcards.

19. The computer-readable medium as in claim 15, wherein associating similar ones of the entity-centric contexts comprises:
mapping, by the device, the entity-centric contexts to vectors in a vector space, wherein two similar entity-centric contexts are deemed similar to one another based on the distance between their respective vectors in the vector space.

20. The computer-readable medium as in claim 19, wherein mapping the entity-centric contexts to vectors in the vector space comprises:
using, by the device, a trained neural network to map the entity-centric contexts to vectors in the vector space.
